(19) United States
(12) Patent Application Publication
(10) Pub. No.: US 2021/0329447 A1
(43) Pub. Date: Oct. 21, 2021

(54) SYSTEM AND METHOD FOR OPERATING A DEVICE

(71) Applicant: GUARDED HORIZONS INC., Gainesville, VA (US)

(72) Inventors: Bobby Thomas Varghese, Gainesville, VA (US); Alper Okutgan, Marmaris (TR)

(73) Assignee: GUARDED HORIZONS INC., Gainesville, VA (US)

(21) Appl. No.: 16/941,519

(22) Filed: Jul. 28, 2020

Related U.S. Application Data
(60) Provisional application No. 63/012,787, filed on Apr. 20, 2020.
(60) Provisional application No. 63/012,797, filed on Apr. 20, 2020.
(60) Provisional application No. 63/012,803, filed on Apr. 20, 2020.

(51) Int. Cl. H04W 12/00; G06Q 30/06; G07C 9/00; H04W 4/14; H04M 3/493; G05D 23/19

(52) U.S. Cl. CPC H04W 12/0027; G06Q 30/0645; G05D 23/1917; H04W 4/14; H04M 3/493; G07C 9/00182

(57) ABSTRACT

A computer-implemented method for managing property includes registering a phone number associated with a phone of a user, receiving a first message or call from a phone of the user, performing a query by an authenticator to determine if the phone number of the phone of the user is registered, sending one or more commands to the phone of the user for the user to select to operate the one or more devices if the phone number of the phone of the user is registered, receiving a command selected by the user to operate a selected device from the one or more commands sent to the phone of the user to operate the one or more devices, and operating the one or more devices upon executing the command selected by the user.

### CROSS-REFERENCE TO RELATED APPLICATIONS

This application claims priority to U.S. Provisional Application No. 63/012,787, filed Apr. 20, 2020, U.S. Provisional Application No. 63/012,797, filed Apr. 20, 2020, and U.S. Provisional Application No. 63/012,803, filed on Apr. 20, 2020, the disclosures of which are incorporated herein by reference.

### FIELD

This application relates to a system and method for operating a device.

### BACKGROUND

Property management systems for rental properties such as bed and breakfast, home vacations, apartments, or other lodgings are used to aid in performing certain tasks related to the property. The properties rented may include single rooms in a hotel or apartment to large houses. Generally, the guest would need to unlock the door to the rented property at the check in time of his or her reservation to get into the rented property. The guest might also want to open the garage door to enter the property or operate some other device during their stay. Often, each of these devices has its own separate device such as remote control or a separate app on a cell phone that is used to operate the device. Also, during their stay, the renter or guest may need specific tasks done such as repairs, they may need the HVAC serviced or require operation of certain devices on the property. Known property management systems suffer from inefficiencies, lack of security, and other deficiencies in handling the reservation process and the tasks related to the rented property. For example, a guest might notice that the air conditioner is broken. The guest may first have to call the property manager to repair the air conditioner. The property manager would first have to ensure that the person calling about the property is the guest that rented the property. After confirming that the person is a renter, the property manager may then have to spend time searching to find the correct HVAC repairman to repair the air conditioner. The property manager may then hire the repairman and communicate with the rental guest and repairman to set up a time to do the repairs. After the repairs are done, the repairmen would have to call the property manager and tell them that the repair is done. Much time is spent checking and calling back and forth the guest, property manager, and repairman regarding the repair of the air conditioner. There are also tasks that involve repeatable functions which create more inefficiencies. It would be desirable to provide a property management system that is an improvement over the known systems and securely streamlines the rental management experience and guest user experience.

It would be desirable to provide a property management system that is an improvement over the known systems and securely streamline the rental management experience and guest user experience.

### SUMMARY

In one aspect of the present invention, a computer-implemented method for managing property is provided. The method includes the following operations performed by at least one processor. These operations include registering a phone number associated with a phone of a user, receiving a first message or call from a phone of the user, performing a query by an authenticator to determine if the phone number of the phone of the user is registered, sending one or more commands to the phone of the user for the user to select to operate the one or more devices if the phone number of the phone of the user is registered, receiving a command selected by the user to operate a selected device from the one or more commands sent to the phone of the user to operate the one or more devices, and operating the one or more devices upon executing the command selected by the user.

In another aspect of the present invention, a non-transitory computer-readable storage medium is provided. The non-transitory computer-readable storage medium stores executable instructions that, as a result of being executed by one or more processors of a computer system, cause the computer system to at least register a phone number associated with a phone of a user, receive a message or call from a phone of the user, perform a query by an authenticator to determine if the phone number of the phone of the user is registered, send one or more commands to the phone of the user for the user to select to operate the one or more devices if the phone number of the phone of the user is registered, receive a command selected by the user to operate a selected device from the one or more commands sent to the phone of the user to operate the one or more devices, and operate the one or more devices upon executing the command selected by the user.

### BRIEF DESCRIPTION OF THE DRAWINGS

FIG. 1 is a block diagram illustrating the general architecture of a client-server application system that operates in accordance with embodiments of the property management system of the present invention;

FIG. 2 is a block diagram of the client device and related elements according to the system of FIG. 1;

FIGS. 3-8 are block diagrams showing components of the property management system and related components at various stages of operation;

FIG. 9 is a block diagram of the Jervis Systems Gateway;

FIG. 10 is a block diagram of the Jervis System Broker Service;

FIG. 11 is a block diagram of the Web Application or API Service, Device, and Device Controller of the property management system of FIG. 1;

FIGS. 12a and 12b define a flow diagram of a method of the property management system FIG. 1 according the present invention;

FIG. 13 is a block diagram of a portion of the property management of FIG. 1 that is used to operate a device according to a first embodiment of the present invention;

FIG. 14 is a block diagram of a portion of the property management system of FIG. 1 that is used to operate a device according to a second embodiment of the present invention;

FIG. 15 is a flow diagram of a method of operation of the portion of the property management system of FIG. 13;

FIGS. 16A to 16B are a schematic front view of a cell phone that show text messages on the display of the cell phone of the originator that provides a command to the originator to operate a device according to method of FIG. 13;

FIGS. 17A to 17F are schematic front views of a cell phone that show text messages displayed on the display of the cell phone of the originator that the commands to operate the devices was executed successfully;

FIG. 18 is a flow diagram of a method of operation of the portion of the property management system of FIG. 14;

FIG. 19 illustrates an interface showing a confirmation message to the guest that agreement is signed in accordance with the method of FIGS. 12a and 12b;

FIG. 20 illustrates an interface showing a message to the guest reminding them that their check-out time is today and another message to a different guest that the rental agreement for their new reservation was sent in accordance with the method of FIGS. 12a and 12b; and

FIG. 21 illustrates an interface showing a message to the guest regarding the check-in details in accordance with the method of FIGS. 12a and 12b.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

As used herein, the term “module” may refer to a hardware based module, software based module or a module may be a combination of hardware and software resources. A module (whether hardware, software, or a combination thereof) may be designed to implement or execute one or more particular functions, tasks or routines of the system. Embodiments of hardware based modules may include self-contained components such as chipsets, specialized circuitry and one or more memory devices. A software-based module may be part of a program code or linked to program code containing specific programmed instructions loaded in a memory device.

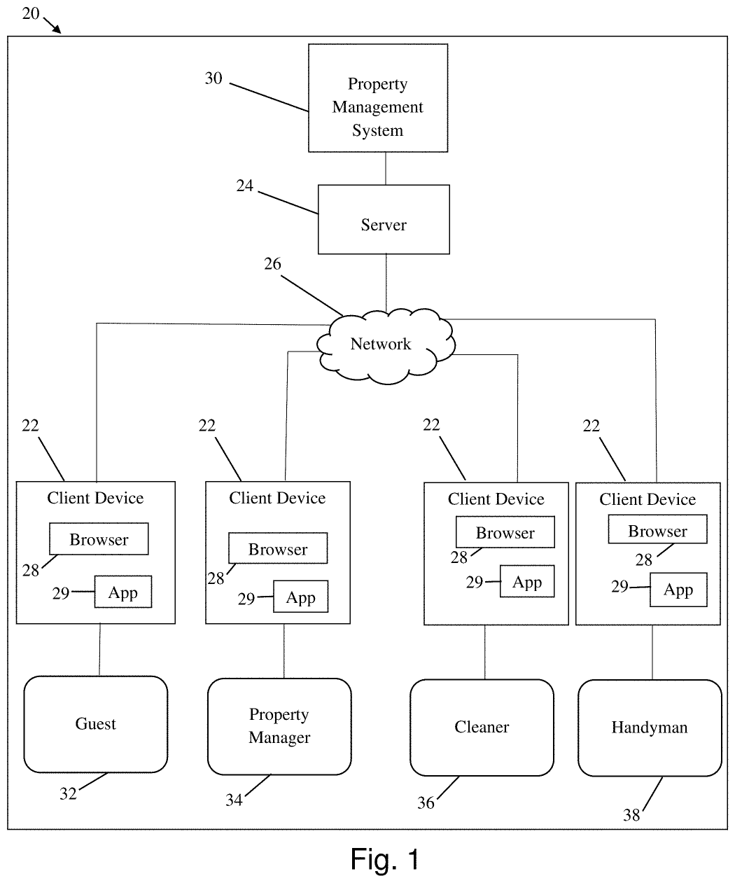

FIG. 1 illustrates the general architecture of a client-server application system 20 that operates in accordance with embodiments of the present invention. Client devices 22 are connected to a system server 24 via a network 26. The system server 24 can be one server or split up into multiple servers for the most efficient deployment and to be able to hand user access and system load.

The system server 24 communicates with the client devices 22 over the network 26 to present a user interface or graphical user interface (GUI) for the service system 20 of the present invention. A property management system 30 of the present invention is in operative connection with the system server 24 and other components of the system 20. The user interface of the service system 20 of the present invention can be presented through a web browser or through a mobile application communicating with the system server 24 and is used for displaying, entering, publishing, and/or managing data required for the service. As used herein, the term “network” generally refers to any collection of distinct networks working together to appear as a single network to a user. The term also refers to the so-called world wide “network of networks” or Internet which is connected to each other using the Internet protocol (IP) and other similar protocols. As described herein, the exemplary public network 26 of FIG. 1 is for descriptive purposes only and it may be wired or wireless. Although the description may refer to terms commonly used in describing public networks such as the Internet, the description and concepts equally apply to other public and private computer networks, including systems having architectures dissimilar to that shown in FIG. 1. The inventive idea of the present invention is applicable for all existing cellular network topologies or respective communication standards, such as GSM, UMTS/HSPA, LTE and the like.

With respect to the present description, the system server 24 may include any service that relies on a database system that is accessible over a network, in which various elements of hardware and software of the database system may be shared by one or more users of the system 20. To this end, the users of a client device 22, from which a request or instruction is received over a network 26, may include any individual customer, a governmental or non-governmental organization, a group etc. The GUI or user interface provided by the system server 24 on the client devices 22 through a web browser 28 or mobile app 29 may be utilized by the users for utilizing service system 20. A client device 22 may be used by the guest 32, property manager 34, cleaner 36, and handyman 38 for interacting with the property management system 30, and can be embodied, for example, in a smartphone. Other users of client devices in this system could be realtors, real estate agents, or any other types of users.

The components of system server 24 would need to be assembled to create the infrastructure to provide the tools and services contemplated by the present invention. As will be apparent to one skilled in the relevant art(s), all of components “inside” of system server 24 may be connected and may communicate via a wide or local area network (WAN or LAN). A web server may be included in the system 20 for sending out Web pages containing electronic data files in response to Hypertext Transfer Protocol (HTTP) requests from remote browsers (i.e. browsers installed in the client devices 22) or in response to similar requests made through a mobile app or mobile application of the present invention installed on a client device 22. The web server can communicate with the mobile app 29 of the present invention and/or with the web browser 28 installed on a client device 22 to provide the user interface required for the service.

The activities related to the service of the present invention can also be performed using the user interface (or GUI) presented through a client device-based web browser. Hereinafter, the term “user interface” is used to refer to both app user interface and the web browser user interface of the present invention. Examples of client device 22 may include, but not limited to, mobile devices, tablets, hand-held or laptop devices, cell phones, smart phones, personal digital assistants, desktop computers, wearable devices, augmented reality glasses, virtual reality headsets, or any similar device.

The property management system 30 may be implemented using a single computer, or a network of computers, including cloud-based computer implementations. The computers are preferably server class computers including one or more high-performance CPUs and 1G or more of main memory, and running an operating system such as LINUX or variants thereof. The operations of the property management system 30 as described herein can be controlled through either hardware or through computer programs installed in non-transitory computer storage and executed by the processors to perform the functions described herein. The database is implemented using non-transitory computer readable storage devices, and suitable database management systems for data access and retrieval. The system 30 includes other hardware elements necessary for the operations described herein, including network interfaces and protocols, input devices for data entry, and output devices for display, printing, or other presentations of data. Additionally, the operations listed here are necessarily performed at such a frequency and over such a large set of data that they must be performed by a computer in order to be performed in a commercially useful amount of time, and thus cannot be performed in any useful embodiment by mental steps in the human mind.

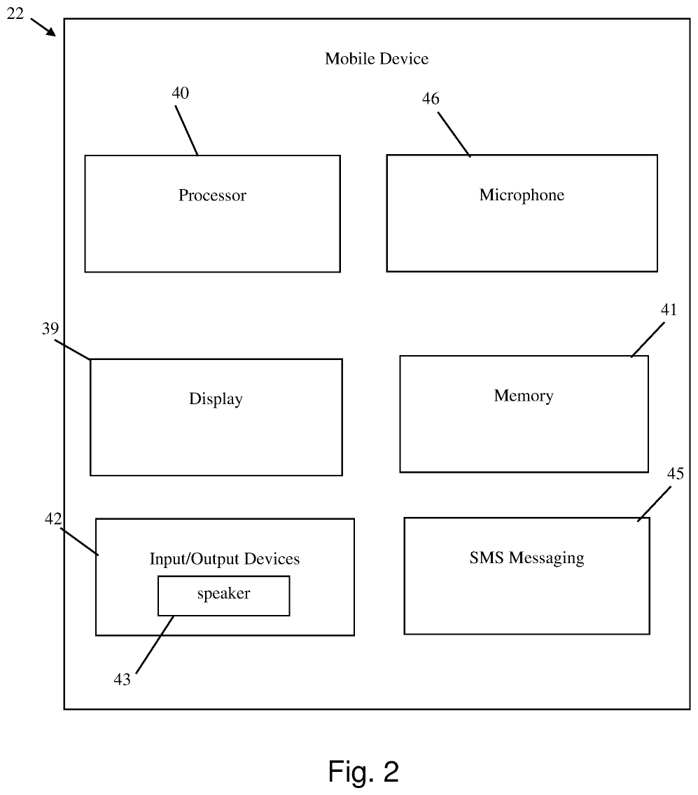

With reference to FIG. 2, the client device 22 may be a portable device such as a mobile device in operative communication with each other. The mobile device 22 may be any computing device small enough to hold and operate in the hand. The mobile device 22 may comprise a display 39 having LCD flat screen interface that provides a touchscreen interface with digital buttons and keyboard, and/or physical buttons along with a physical keyboard. The mobile device 22 may connect to the internet and interconnect with other devices such as car entertainment systems or headsets via Wi-Fi, Bluetooth, cellular networks or near field communication (NFC). The mobile device 22 may be a cell phone, smart phone, smart watch, tablet, PDA, laptop, notebook or other suitable portable or mobile device. The mobile device 22 is configured to detect its location and hence the location of a user using the mobile device 22 or another person near the mobile device 22. The mobile device may include location services such as GPS to determine the location of the mobile device 22. The mobile device may also include a photo album for existing photos or pictures taken or stored by the mobile device 22. The mobile device 22 may include a web browser 28 and/or a mobile app 29. Alternatively, the mobile device 22 may be a standalone mobile device 22 such as a standalone cell phone without a browser or mobile app.

The mobile device 22 includes one or more processors 40 and a memory device 41. The memory device 41 may contain a user identification module that may in turn contain a user identifier and/or user information. The user identifier may be a unique number or code that uniquely identifies the user of the mobile device. The mobile device 22 may also include input/output devices 42 such as a camera capable of taking still or video pictures and have the capability to make video calls. An antenna in the mobile device may send and receive wireless signals from sources such as the radio antenna and satellite. The antenna may, in some implementations, communicate directly with the server such as by exchanging wireless signals. The mobile device 22 may further comprise other input/output devices 42, such as a microphone 46 and a speaker 43 used, for example, in an implementation in which the mobile device 22 functions as a telephone. In some implementations, the mobile device 22 may also include a calendar/clock and a network interface. The calendar/clock may calculate time, date, and other data that can be derived from time data and date data. The mobile device may include SMS (Short Messaging Service) messaging 45 for use in sending and receiving text messages.

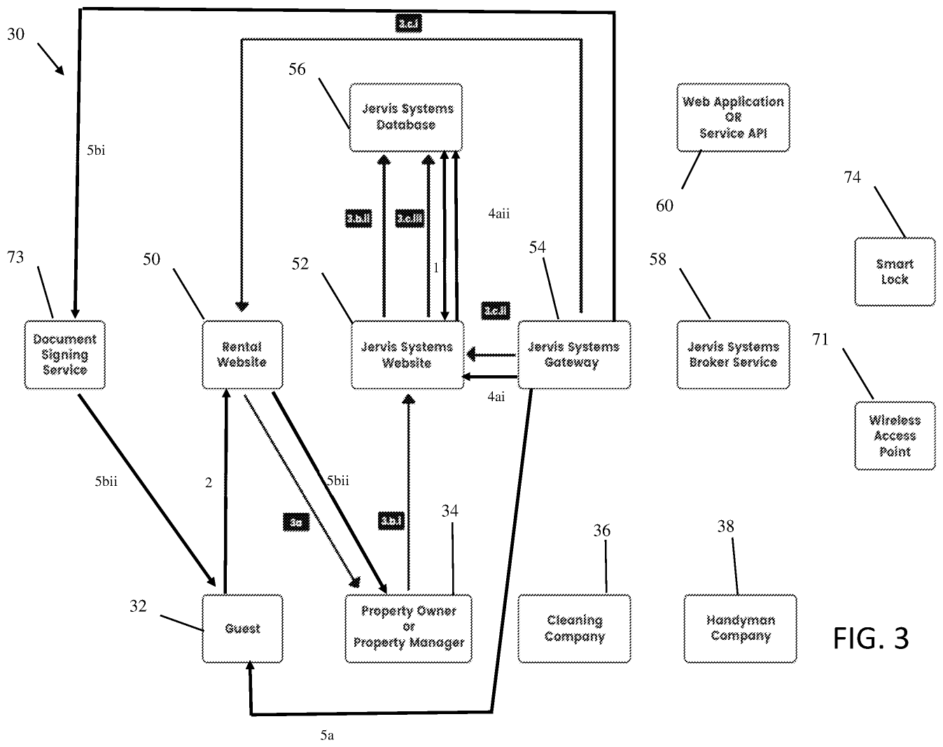

FIGS. 3-11, 13, and 14 show components of the property management system 30. Some components are named Jervis for illustrative purpose. Referring to FIG. 3, the property management system 30 comprises a rental website 50, a Jervis Systems Website 52, a Jervis Systems Gateway 54, Jervis system Database 56, a Jervis Systems Broker Service 58, and a Web Application or API Service 60. The rental website 50 is used to enable a guest to make a reservation to rent a property. The Jervis Systems Website 52 receives the reservation details and stores them in the Jervis Systems Database 56. The property owner or property manager can manually input the reservation details as well as Jervis Systems Website 52 pulling these details directly from a rental website 50 via their API service 60 if possible.

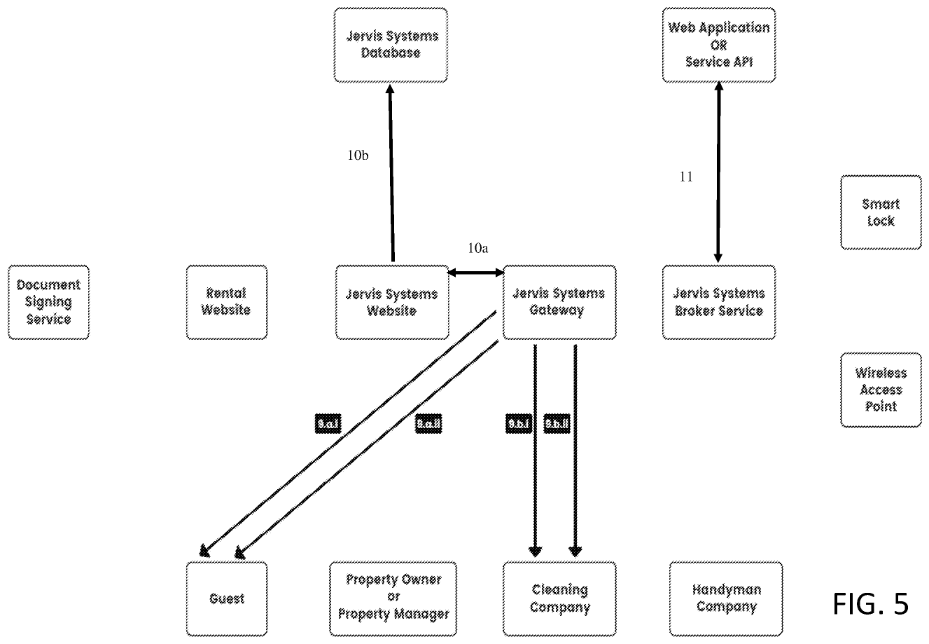

The Jervis Systems Website 52 maintains a continuous connection to the Jervis Systems Database 56 as depicted by arrow 10a in FIG. 5. The Jervis Systems Gateway 54 uses the Jervis Systems Website 52 to input reservation details into the property owner or property manager profile.

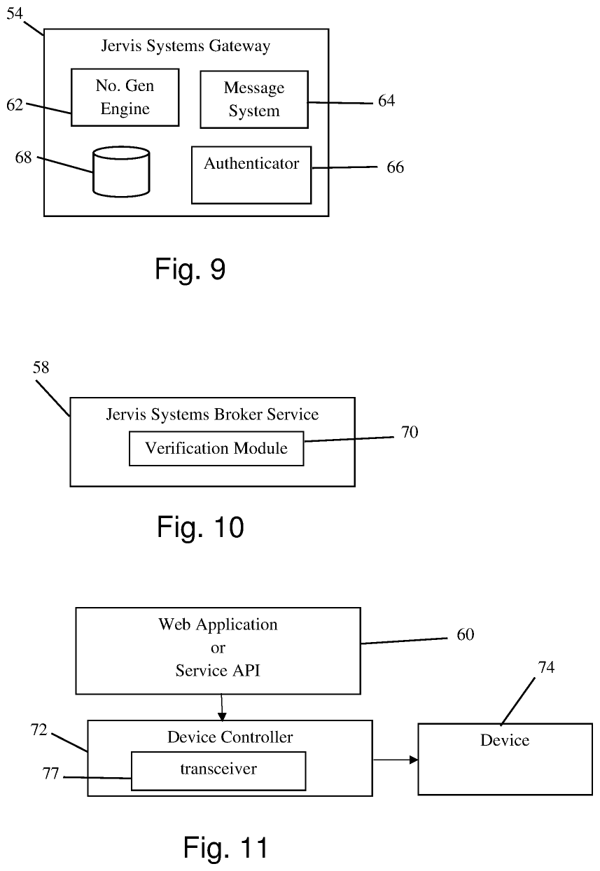

As illustrated in FIG. 9, the Jervis System Gateway 54 includes a random generator engine 62, a message system 64, an authenticator 66, and a data store 68. The random generator engine 62 is operative to generate random characters such as random numbers, letters, alphanumeric characters, punctuation characters, special character, letters or characters from foreign languages, other types of characters, or combinations of these types of characters. The Jervis Systems Gateway 54 is the “brains” of the processes and will use this connection to supply the process with required information. The Jervis Systems Website 52 queries the Jervis Systems Database 56 for required information as depicted by arrow 10b in FIG. 5. The Jervis Systems Gateway 54 passes information to the Jervis Systems Broker Service 58. The Jervis Systems Broker Service 58 sends commands to the Web Application or API Service 60. The Jervis Systems Broker Service 58 includes a verification module 70 as illustrated in FIG. 10. As shown in FIG. 5, the property management system 30 may include a wireless access point 71 and a document signing service 73. The property management system may include a device controller 72 for operating a device 74 as shown in FIG. 11. For example, the device controller 72 may be a smart lock controller 72 for operating a smart lock 74. The device controller may include a transceiver 77. The device 74 can be any suitable device that may be connected to the internet or can otherwise be operated by a cell phone. For example, the device can be a smart lock as shown in FIGS. 3-8, wireless access points, a smart garage door opener, one or more light controllers, a ceiling fan controller, or a temperature controller.

The Jervis Systems Gateway 54 and Jervis Systems Broker Service 58 may each be a hardware-based module, software-based module or a module that is a combination of hardware and software resources. As previously mentioned, a module (whether hardware, software, or a combination thereof) may be designed to implement or execute one or more particular functions, tasks or routines of the system. Embodiments of hardware-based modules may include self-contained components such as chipsets, specialized circuitry and one or more memory devices. A software-based module may be part of a program code or linked to program code containing specific programmed instructions loaded in a memory device. The Jervis Systems Broker service 58 and/or Jervis Systems Gateway 54 may act as a proxy server or module that bridges or acts as an intermediary to enable communication between devices connect to them of information or commands passing through them and to simplify or control the complexity of the information or provide additional benefits such as load balancing, privacy, or security.

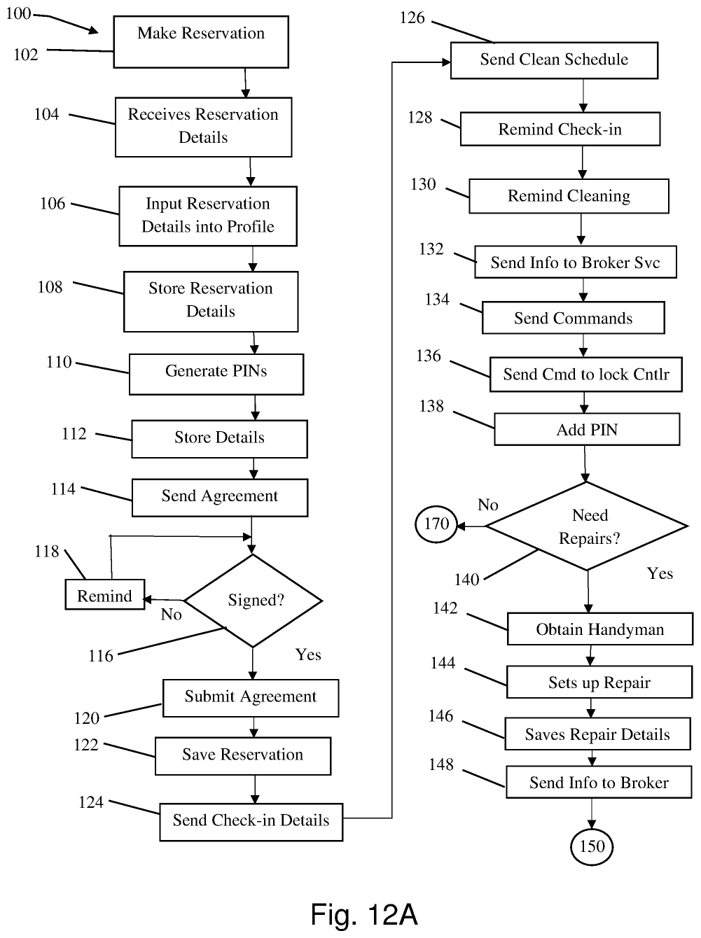

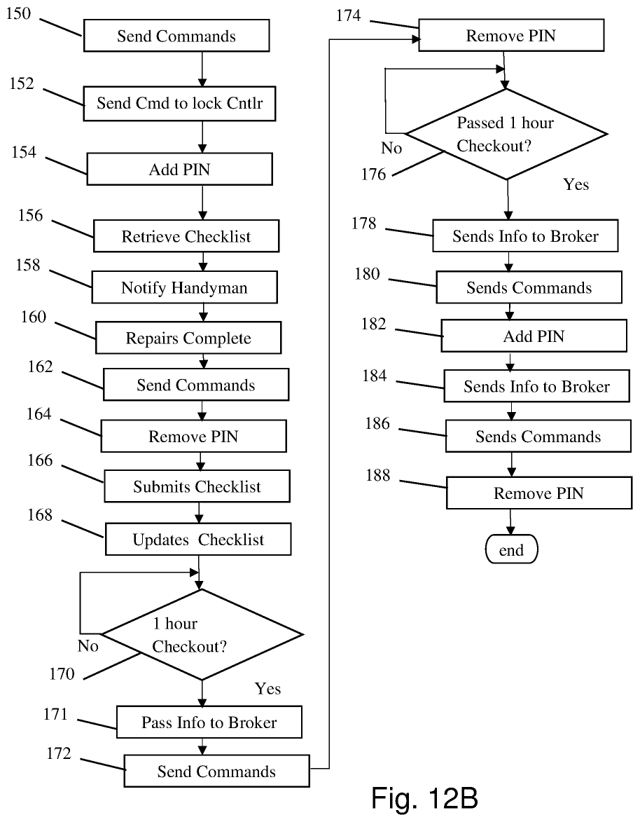

With reference now to FIGS. 12a, 12b, 15, and 18, example methodologies are illustrated and described. While each methodology is described as a series of acts or steps that are performed in a sequence, it is to be understood that each methodology is not limited by the order of the sequence. For instance, some acts or steps may occur in a different order than what is described herein. In addition, a step may occur concurrently with another step. Furthermore, in some instances, not all steps may be required to implement a methodology described herein.

Moreover, the steps or acts described herein may be computer-executable instructions that can be implemented by a processor or one or more processors and/or stored in the memory and/or on a computer-readable medium or media. The computer-executable instructions may include a routine, a sub-routine, programs, a thread of execution, and/or the like. Still further, results of acts of the methodology may be stored in a computer-readable medium, displayed on a display device, and/or the like. The computer-readable storage medium may be non-transitory.

FIG. 12a shows a method 100 comprising operative sequence of steps for automatically sending and tracking rental agreements of a property rented by a guest and adding and removing randomly generated codes for the guest, cleaning company or cleaner, and handyman or repairperson or repair company for use in performing tasks and operating devices associated with the property of the property management system 30 according to the present invention. In addition, adding and removing randomly generated codes may be included for other users such as realtors or real estate agents. In step 102, the guest makes a reservation through a rental website 50 or a direct website such as Airbnb® that is synced with the rental website 50 as depicted by arrow 2 in FIG. 3. The property owner or property manager receives notifications from the rental website 50 of the reservation or booking as depicted by arrow 3a in FIG. 3. In step 104, the Jervis Systems Website 52 receives the reservation details. In one example, the property owner or property manager may manually input reservation details into the Jervis System website as depicted by arrow 3bi in FIG. 3. Alternatively, the Jervis Systems Gateway 54 may retrieve the reservation through an authenticated Application Program Interface (API) connection to the rental website 50 as depicted by arrow 3ci in FIG. 3. In step 106, the Jervis Systems Gateway 54 uses the Jervis Systems Website 52 to input reservation details into the property owner or property manager profile as depicted by arrow 3cii in FIG. 3.

In step 108, the Jervis Systems Website 52 stores details into the Jervis Systems Database 56 as depicted by arrow 1 in FIG. 3. These details are inputted into the database as follows:

1. First name

2. Last name

3. Cell phone number

4. Email

5. Check-in date

6. Check-in time

7. Check-out time and check-out date

8. Randomly generated but not duplicated reservation ID

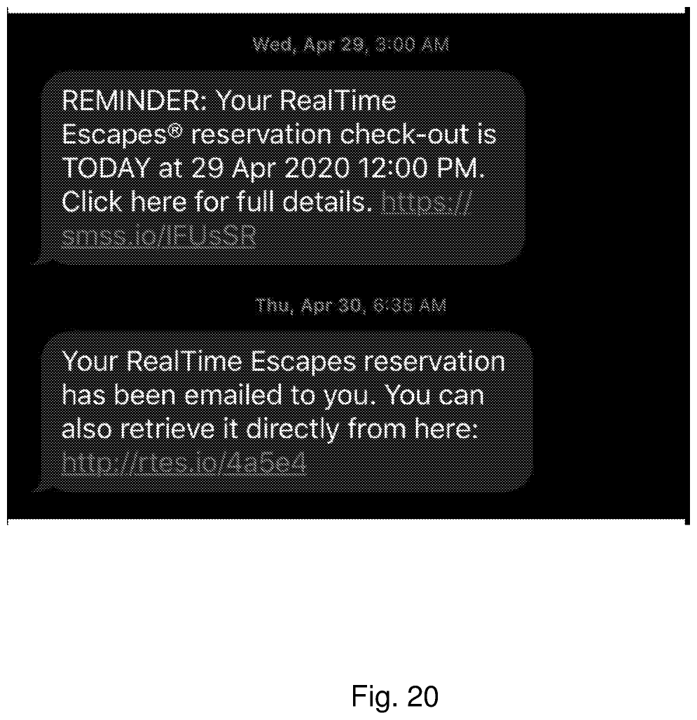

It should be noted that more details can be stored into the database at a later time or now. In step 110, the random generator engine 62 of the Jervis Systems Gateway 54 generates 3 random personal identification numbers (PINs) that each have 4-8 digits and will be used in the Jervis Systems Website 52 to be inputted under the property owner or property manager profile as depicted by arrow 4ai in FIG. 3. Other types of characters can be used instead of numbers for the PINs such as letters, alphanumeric characters, punctuation characters, special character, letters or characters from foreign languages, or combinations of these types of characters. One generated PIN will be for the guest, one generated PIN will be for the cleaning company, and one generated PIN will be for the handyman company (if needed for repairs). In step 112, the Jervis Systems Website 52 stores the details into the Jervis Systems Database 56 under the property owner or property manager profile for the associated guest reservation made in step 102 as depicted by arrow 4aii in FIG. 3. In step 114, the Jervis Systems Gateway 54 sends a rental agreement directly to a client device 22 of the guest and they are notified via text message and email message as shown in FIG. 20 that the reservation has been sent as depicted by arrow 5a in FIG. 3. Optionally, the Jervis Systems Gateway 54 may orchestrate sending the rental agreement through the document signing service 73 using APIs as depicted by arrow 5bi in FIG. 3. The document signing service 73 then sends the rental agreement to the client device 22 of the guest as depicted by arrow 5bii in FIG. 3.

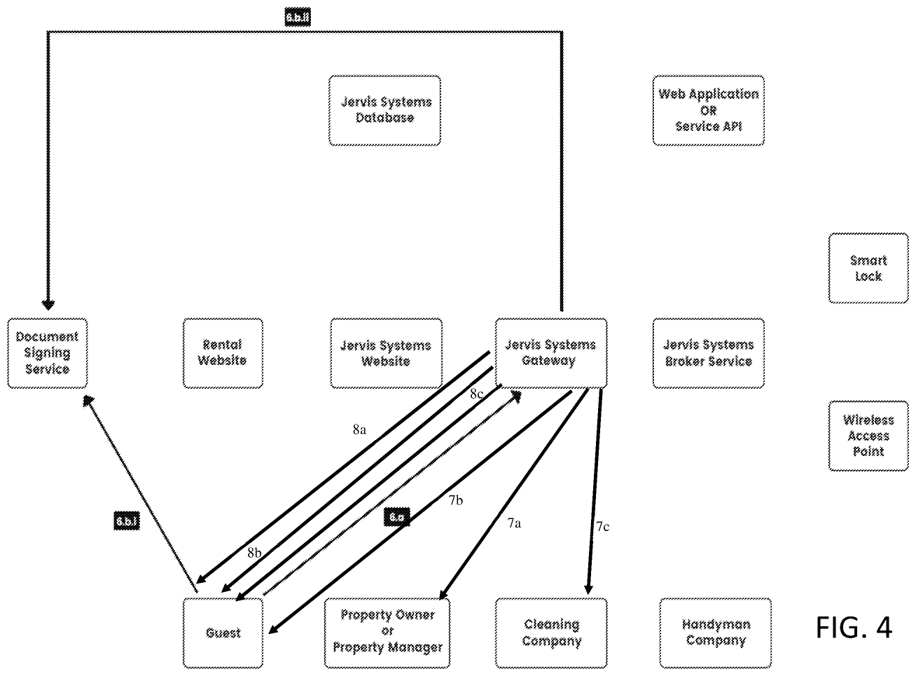

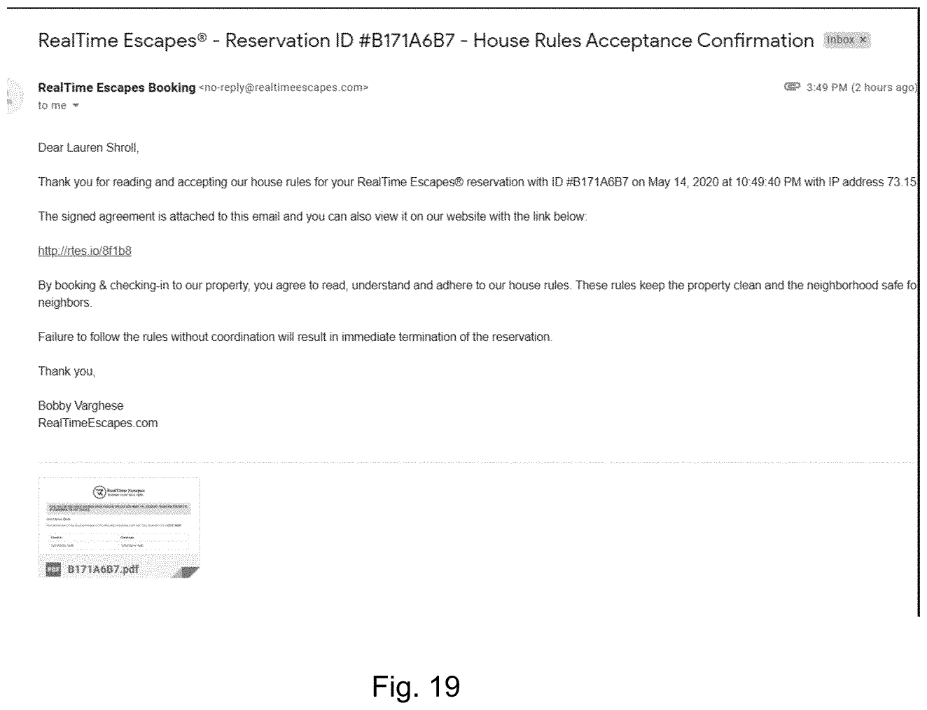

In step 116, a query is then done to determine if the rental agreement is signed or not. If the rental agreement is not signed, the guest is reminded via emails, text messages, notifications or other suitable way on their client device 22 by the Jervis Systems Gateway 54 a certain time before check-in in step 118 as depicted by arrows 8a, 8b, and 8c in FIG. 4. For example, the guest may be reminded 2 days before check-in date and time. The process then goes back and checks again. If the rental agreement is not signed, then Jervis Systems Gateway 54 reminds the guest again at a predetermined time such as 1 day before the check-in date and time. The process then goes and check again. If the rental agreement is not signed, the Jervis Systems Gateway 54 reminds the guest again to sign the agreement at a predetermined time before the check in date such as 4 hours before the check-in date and time. This can be a configurable setting as the number of reminders and time can be changed by an authorized user such as the property owner, property manager or an associate of the property owner or property manager. If the rental agreement is signed, then the Jervis Systems Gateway 54 stops reminding the guest to sign the rental agreement and confirms via an email and/or text message to the guest that the rental agreement is signed as shown in FIG. 19. The process then goes to step 120.

In step 120, after the rental agreement is reviewed and signed digitally by the guest, the rental agreement is submitted back to Jervis Systems Gateway 54 as depicted by arrow 6a in FIG. 4. Optionally, the guest may sign the rental agreement and submit it back to the document signing service 73. Then, the Jervis Systems Gateway 54 orchestrates retrieving the rental agreement through the document signing service 73 through APIs as depicted by arrows 6bi and 6bii in FIG. 4.

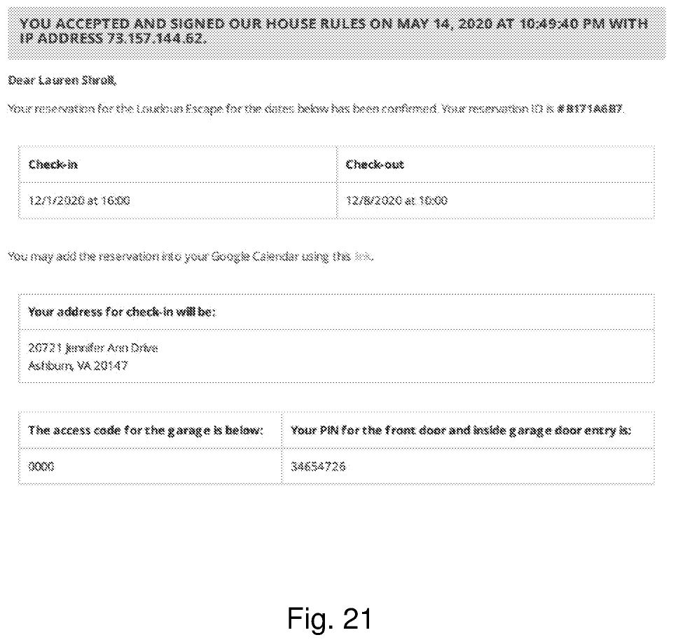

Then in step 122, the Jervis Systems Gateway 54 saves the signed rental agreement to the Jervis System database with the guest reservation details and then sends the reservation details to a client device 22 of the property manager and property owner as well as calendar links to save the reservation into various calendars with reminders as depicted by arrow 7a in FIG. 4. In step 124, the Jervis Systems Gateway 54 sends check-in details with the property address and check-in details to the client device 22 of the guest via the message system as depicted by arrow 7b in FIG. 4. Check-in details include the door code and guest wireless network code as illustrated in FIG. 21. The code is not put on the door at this time. In step 126, the Jervis Systems Gateway 54 sends the date and time of scheduled cleaning via email and text message to a client device 22 the cleaning company using the message system 64 as depicted by arrow 7c in FIG. 4. It should be noted that the order of steps 122-126 may change as to how notifications are sent, when and to whom. After the rental agreement is signed, in step 128, the Jervis Systems Gateway 54 sends reminder messages to the client device 22 of the guest containing the check-in details as depicted by arrows 9ai and 9aii in FIG. 5. For example, the check-in details reminder message may be sent 1 day before check-in date and check-in time and 2 hours before check-in date and check-in time. The check-in details reminder message may be sent via email and/or text message. The number of check-in details reminder messages and timing may be a configurable setting to be change by an authorized user such as the property owner, property manager or an associate of the property owner or property manager. One or more reminder messages may also be sent at certain times before the guest checks out to remind the guest to check out at the check-out time as shown in FIG. 20.

In step 130, the Jervis Systems Gateway 54 sends cleaning reminder messages to the client device 22 of the cleaning company to clean the property rented by the guest at a date and time via email and/or text messages as depicted by arrows 9bi and 9bii in FIG. 5. For example, cleaning reminder messages may be sent 1 day before the cleaning date and time and 4 hours before cleaning date and time. The number of cleaning reminder messages, to whom they are sent and the timing of messages are configurable settings that can be changed by an authorized user such as the property owner, property manager or an associate of the property owner or property manager.

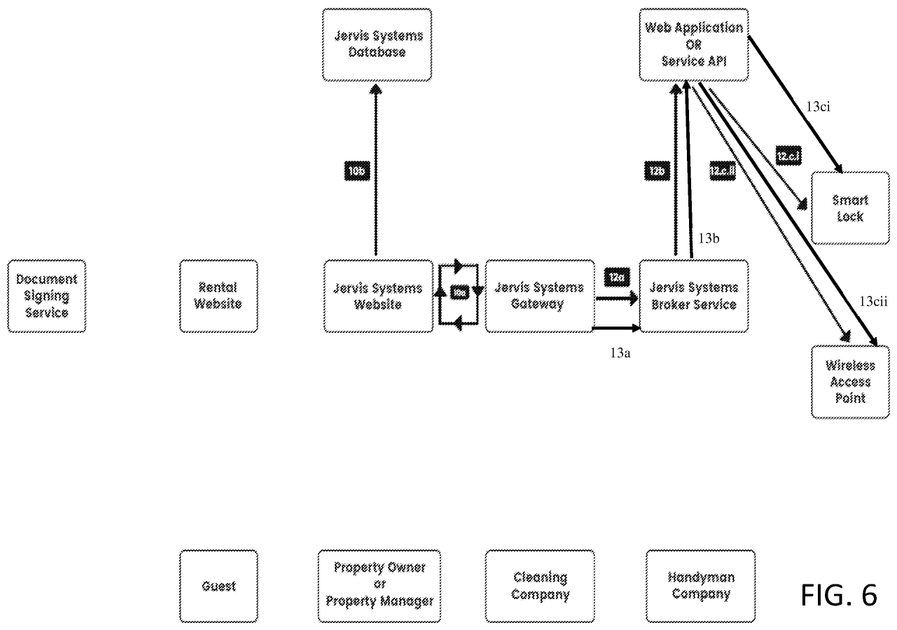

In step 132, before the check-in date and check-in time, the Jervis Systems Gateway 54 passes information to Jervis Systems Broker Service 58 about the PIN for the guest as depicted by arrow 12a in FIG. 6. In step 134, the Jervis Systems Broker Service 58 sends commands to the Web Application or API Service 60 for the smart lock 74 and wireless access point 71 to add the randomly generated PIN for the guest as depicted by arrow 12b in FIG. 6. This PIN becomes the unique code for the guest that they use to unlock/lock the door as well as their unique password for the guest wireless network. It should be noted that the Jervis Systems Broker Service 58 maintains a continuous connection to Web Application or API Service 60 for the smart lock 74 and wireless access point 71 as depicted by arrow 11 in FIG. 5.

In step 136, the Web Application or API Service 60 sends commands to the smart lock controller 72 to add and store the randomly generated PIN for the guest to the controller 72 as depicted by arrow 12ci in FIG. 6. Thus, when the guest enters this PIN on the keypad of the smart lock 74 or on the client device (e.g. cell phone) of the guest, the door is unlocked if is currently locked, or locked if it is currently unlocked. Alternatively, the guest could enter a command or button in the Jervis application or through a web browser. In step 138, the Web Application or API Service 60 sends commands to the wireless access point 71 to add and store the randomly generated PIN for the guest to the wireless access point 71 as depicted by arrow 12cii in FIG. 6, so that the guest can enter this PIN on the client device or other input device to get wireless access.

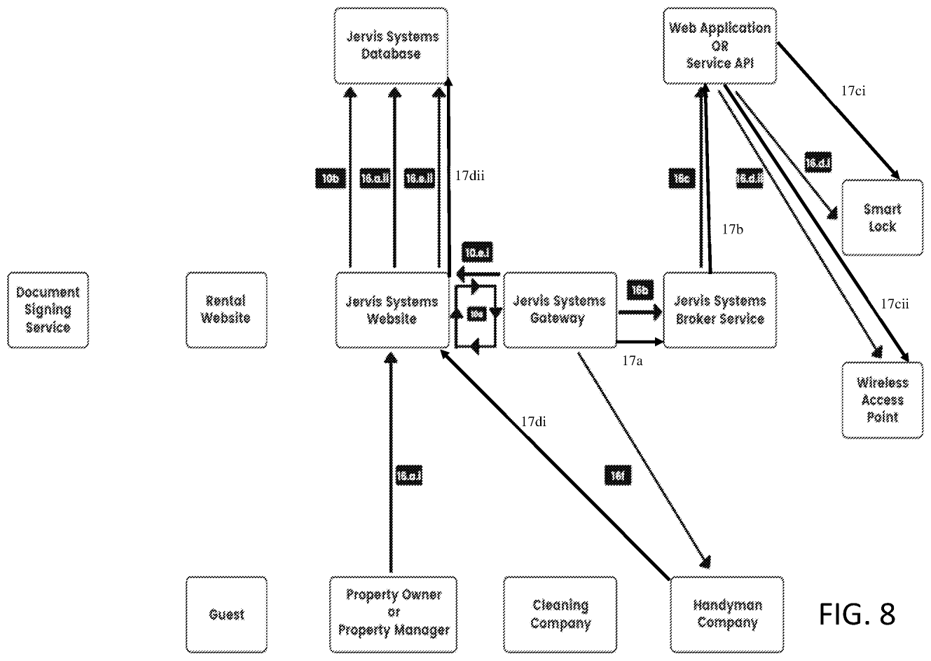

In step 140, a query is made to determine if any property repairs are needed after a reservation is completed. If no repairs are need, the method goes to step 170. If a repair is needed, then in step 142, the property owner or property manager logs into Jervis Systems Website 52 to select a registered handyman they would like to work with in their area or register their own handyman into the system (company name, email, phone number) as depicted by arrow 16ai in FIG. 8. Then in step 144, the property owner or property manager creates a checklist for the handyman company, associates the repair with the specific reservation or sets it up to be a one-off repair. The date and time that the repair needs to be done is also entered in the check list. In the context of short-term rentals (Airbnb®, etc.), these repairs may be done after the rental is complete or during the rental. In the context of traditional long-term rentals, repairs may be done during a rental. Then, in step 146, the Jervis System Website saves these details into the Jervis Systems Database 56 as depicted by arrow 16aii in FIG. 8.

Then, in step 148, the Jervis Systems Gateway passes information to the Jervis Systems Broker Service 58 about the PIN for the handyman as depicted by arrow 16b in FIG. 8. Then, with reference to FIG. 12b, in step 150, the Jervis Systems Broker Service 58 sends commands to Web Application or API Service 60 for the smart lock 74 and wireless access point 71 to add the randomly generated PIN for the handyman company, so that the handyman can gain access in to the property as depicted by arrow 16c in FIG. 8.

Then, in step 152, the Web Application or API Service 60 sends commands to the smart lock controller 72 to add and store the randomly generated PIN for the handyman company to the controller 72 as depicted by arrow 16di in FIG. 8. Thus, when the handyman enters this PIN on the keypad of the smart lock 74 or on the client device (e.g. cell phone) of the handyman, the door is unlocked if it is currently locked, or locked if it is currently unlocked. Alternatively, the handyman could enter a command or button in the Jervis application or through a web browser. In step 154, the Web Application or API Service 60 sends commands to the wireless access point 71 to add and store the randomly generated PIN for the handyman to the wireless access point 71 as depicted by arrow 16dii in FIG. 8, so that the handyman can enter this PIN on the client device or other input device to get wireless access.

Then, in step 156, the Jervis Systems Gateway 54 connects to Jervis Systems Website 52 and the Jervis Systems Website 52 retrieves the checklist for the handyman based on the reservation and assigned handyman by the property owner or property manager as depicted by arrow 16eii in FIG. 8. In step 158, the Jervis Systems Gateway 54 notifies the handyman company via an email and text message to a client device 22 of the handyman containing the smart lock code, the wireless access point code (if wireless access to the wireless network associated with the property is needed), the time window for access, and the checklist of items to be fixed which links to Jervis Systems Website 52 as depicted by arrow 16f in FIG. 8. It should be noted that the time for fixing the items is configurable.

After property repairs are completed, then in step 160, the Jervis Systems Gateway 54 receives the information that the property repairs are complete and passes that information to Jervis Systems Broker Service 58 as depicted by arrow 17a in FIG. 8. In step 162, the Jervis Systems Broker Service 58 sends commands to the Web Application or API Service 60 for the smart lock 74 and the wireless access point 71 to remove the randomly generated PIN for the handyman company as depicted by arrow 17b in FIG. 8. In step 164, the Web Application or API Service 60 sends commands to the smart lock 74 to remove the randomly generated PIN for the handyman company from the smart lock controller 72, and to the wireless access point 71 to remove the randomly generated PIN for the handyman company from the wireless access point 71 as depicted by arrows 17ci and 17cii in FIG. 8.

In step 166, the handyman company submits the completed handyman checklist to the Jervis Systems Website 52. For example, the handyman may manually input information using their client device 22 into an online checklist form in the Jervis System Website as depicted by arrow 17di in FIG. 8. In step 168, the Jervis Systems Website 52 updates the checklist for the handyman based on the reservation and the assigned handyman by the property owner or property manager as depicted by arrow 17dii in FIG. 8.

In step 170, a query is made to determine if 1 hour after the check-out time has been reached. This time can be configurable by the property staff such as the property manager or owner. If so, then in step 171, the Jervis Systems Gateway 54 passes information to the Jervis Systems Broker Service 58 as depicted by arrow 13a in FIG. 6. In step 172, the Jervis Systems Broker Service 58 sends commands to the Web Application or API Service 60 for the smart lock 74 and the wireless access point 71 to remove the randomly generated PIN for the guest as depicted by arrow 13b in FIG. 6. In step 174, the Web Application or API Service 60 sends commands to a) the smart lock 74 to remove the randomly generated PIN for the guest from the smart lock controller 72, and b) to the wireless access point 71 to remove the randomly generated PIN for the guest from the wireless access point 71 as depicted by arrows 13ci and 13cii in FIG. 6.

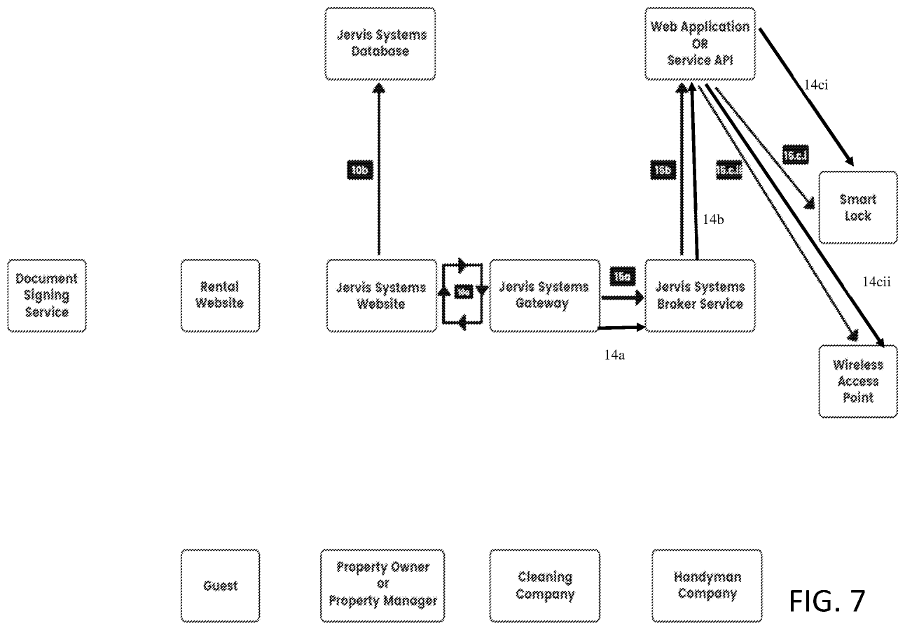

In step 176, a query is made to determine if 1 hour after the guest check-out date and the check-out time has been passed. This time can be configurable by the property staff such as the property staff such as the property manager or owner. If so, then, in step 178, the Jervis Systems Gateway 54 passes information to Jervis Systems Broker Service 58 about the PIN for the cleaning company as depicted by arrow 14a in FIG. 7. In step 180, the Jervis Systems Broker Service 58 sends commands to the Web Application or API Service 60 for the smart lock 74 and wireless access point 71 to add the randomly generated PIN for the cleaning company as depicted by arrow 14b in FIG. 7. In step 182, the Web Application or API Service 60 sends commands to a) the smart lock 74 to add and store the randomly generated PIN for the cleaning company to the smart lock controller 72, and b) the wireless access point 71 to add and store the randomly generated PIN for the cleaning company to the wireless access point 71 for accessing the wireless network associated with the property as depicted by arrows 14ci and 14cii in FIG. 7. Thus, when the cleaning company associate enters this PIN on the keypad of the smart lock 74 or on the client device (e.g. cell phone) of the cleaning company associate, the door is unlocked if it is currently locked, or locked if it is currently unlocked. Alternatively, the associate could enter a command or button in the Jervis application or through a web browser. The cleaning company associate can enter this PIN on the client device or other input device to also get wireless access.

After the cleaning period is completed, then in step 184, the Jervis Systems Gateway 54 passes information to Jervis Systems Broker Service 58 as depicted by arrow 15a in FIG. 7. In step 186, the Jervis Systems Broker Service 58 sends commands to the Web Application or API Service 60 for the smart lock 74 and wireless access point 71 to remove the randomly generated PIN for the cleaning company as depicted by arrow 15b in FIG. 7. In step 188, the Web Application or API Service 60 sends commands to a) the smart lock 74 to remove the randomly generated PIN for the cleaning company from the smart lock controller 72, and b) the wireless access point 71 to remove the randomly generated PIN for the cleaning company from the wireless access point 71. In this method, the Jervis Systems Gateway 54 maintains a continuous connection to Jervis Systems Website 52 as depicted by arrows 15ci and 15cii in FIG. 7. The completion of the cleaning period may be determined by any suitable way. For example, the completion of the cleaning period may be determined by the reaching of a predetermined time after the date and time that was scheduled for the cleaning for the guest or by receiving information by the cleaner that the cleaning is complete. Alternatively, a different PIN for the wireless access point 71 for each of the guest, handyman, and cleaning company could be randomly generated by random generator engine 62 and added to the wireless access point 71 instead of using the same PIN for the smart lock 74. The PIN for each of the guest, handyman, and cleaning company can be edited or changed.

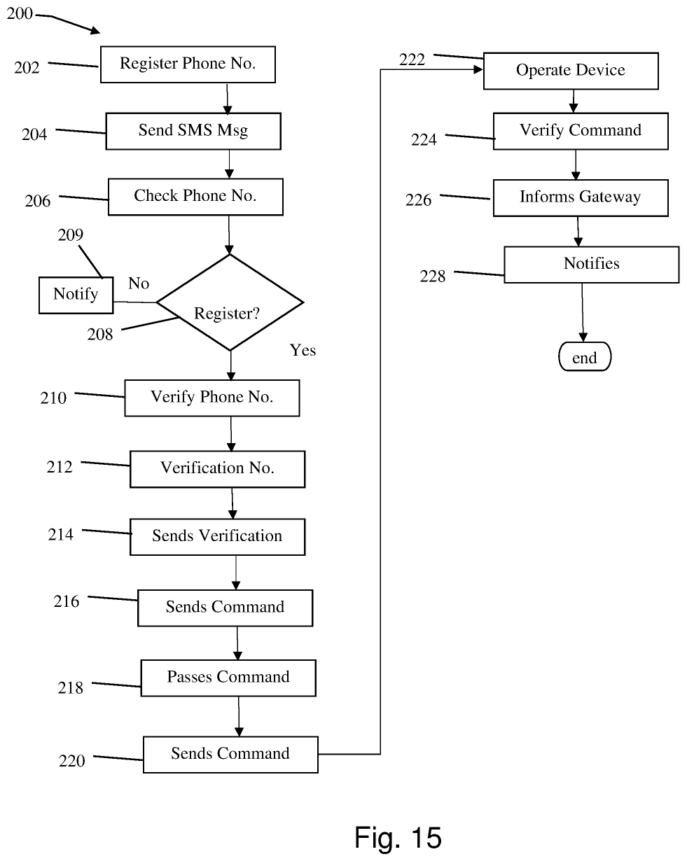

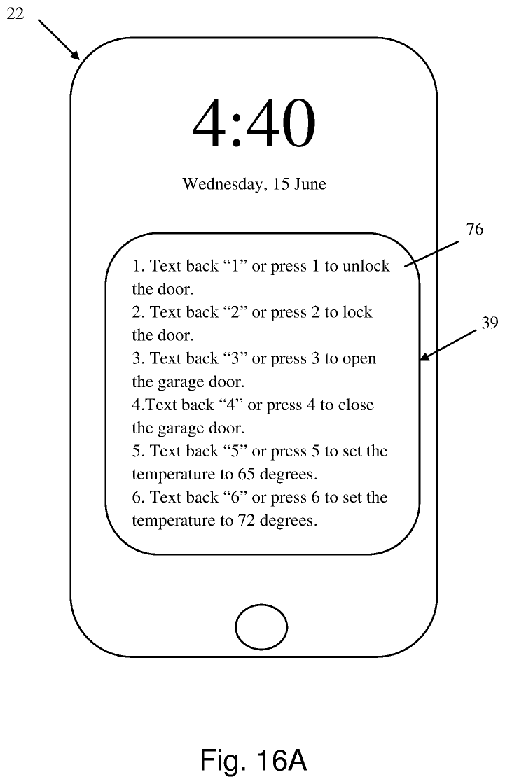

The property management system 30 may also include components that are utilized to allow a guest to execute commands to operate one or more devices 74 associated with the property. The device 74 can be any suitable device. The device 74 may be connected to the Internet. For example, the device can be a smart lock as shown in FIGS. 3-8, wireless access points, a smart garage door opener, one or more light controllers, a ceiling fan controller, or a temperature controller. FIG. 15 shows a method 200 comprising operative sequence of steps for operating devices associated with the property according to a first embodiment. The method generally includes sending a text message to a phone number of a user or originator that is managed by the Jervis Systems Gateway 54. The user is verified to be an authorized number and then is sent back a list of possible commands that can be executed. The Jervis Systems Broker Service 58 takes these messages sent via SMS or any messaging protocol such as MMS (Multimedia Messaging Service), EMS (Enhanced Messaging Service) and others. In this embodiment SMS messages will be used and referenced, but it should be noted that other types of messaging protocols could be used as well. These SMS messages are mapped into commands. These commands can be sent and executed on services that are hosted online and have a publicly accessible API or is accessible from an Internet browser. The user is notified that the commands were successfully executed and can send other commands if needed. The user or originator may be a guest, cleaning company associate, handyman, property manager or associate or other type of user.

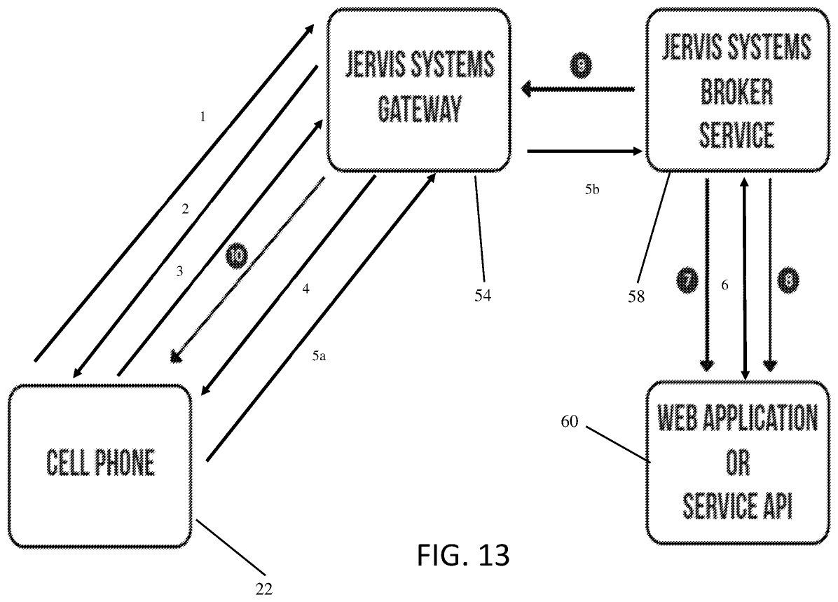

In particular, the method begins in step 202, in which a guest or other user registers the phone number of their cell phone with the Jervis Systems Gateway 54. In the registration process, the phone number is received and stored in the data store 68 of the Jervis Systems Gateway 54. The Jervis Systems Gateway 54 is configured such that only SMS (short message service) or other messaging protocols (e.g. MMS, EMS etc.) messages from authorized phone numbers stored in the data store 68 of the Jervis Systems Gateway 54 during an approved period will be acted upon. In step 204, an SMS message is sent from the cell phone or other client device of the user of the authorized phone number to the Jervis Systems Gateway 54 as depicted by arrow 1 in FIG. 13. The SMS message may be a request to operate one or more devices 74 associated with the property. In step 206, the authenticator of the Jervis Systems Gateway 54 checks the phone number of the cell phone of the user and determines in step 208 whether the phone number has been registered with the Jervis Systems Gateway 54. If the authenticator 66 of the Jervis System Gateway 54 was not able to find an authorized number, then in step 209, its message system 64 would prompt or notify the user with a message that states “We are unable to find that you are registered in our system. Please contact your property owner or property manager to verify access”. If the authenticator of the Jervis Systems Gateway 54 determines that the phone number is registered with the Jervis Systems Gateway 54, then in step 210 the messaging system of the Jervis System sends a 2-4-digit verification number or code via SMS message or email back to the cell phone 22 as an email or text for the user to verify that this message originated from the cell phone 22 to thereby provide number spoof protection as depicted by arrow 2 in FIG. 13. Instead of a number, the verification code can include letters, alphanumeric characters, punctuation characters, special character, letters or characters from foreign languages, other types of characters, or combinations of these types of characters.

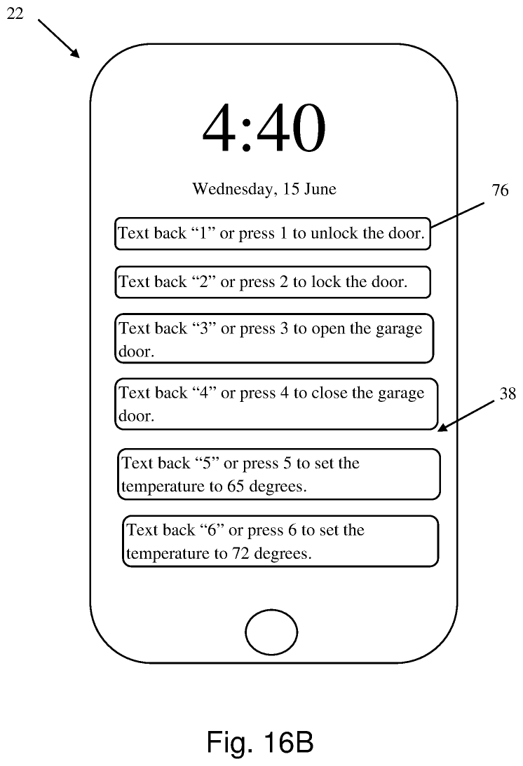

In step 212, the originator submits the received 2-4-digit verification number to the phone number managed by the Jervis Systems Gateway 54 via SMS as depicted by arrow 3 in FIG. 13. In step 214, the Jervis Systems Gateway 54 sends an SMS message back to the originator that they have been verified as depicted by arrow 4 in FIG. 13. Options for commands that can be submitted via SMS is provided back to the originator. These SMS messages are mapped into commands. For example, FIGS. 16A and 16B each shows a text message 76 on the display 39 of the cell phone 22 of the originator that provides a command to the originator to open the garage door. The SMS messages are mapped into commands. The commands for various devices may be all included on one text messages as shown in FIG. 16A or alternatively, several text messages may be displayed in which each text message includes one command as shown in FIG. 16B. Alternatively, an email containing the commands may be sent to the cell phone 22 of the originator. In step 216, the originator sends or text the command they wish to execute via SMS to the phone number managed by the Jervis Systems Gateway 54 as depicted by arrow 5a in FIG. 13. In step 218, the Jervis Systems Gateway 54 passes the commands to be executed to the Jervis Systems Broker Service 58 as depicted by arrow 5b in FIG. 13.

In step 220, the Jervis Systems Broker Service 58 sends commands to the Web Application or API Service of the solution. The Jervis Systems Broker Service 58 maintains a connection to the Web Application or API Service of solution to enable the commands to be sent to them as depicted by arrow 6 in FIG. 13. In step 222, the Web Application or the API Service of solution sends the commands to the device to operate the device as depicted by arrow 7 in FIG. 13. In step 224, the verification module of the Jervis Systems Broker Service 58 verifies that the commands were executed to operate the device or not executed to operate the device as depicted by arrow 8 in FIG. 13. The verification module keeps trying for a preconfigured number of attempts to make this determination. The number of attempts is configurable in the Jervis Systems Gateway Dashboard (administration panel).

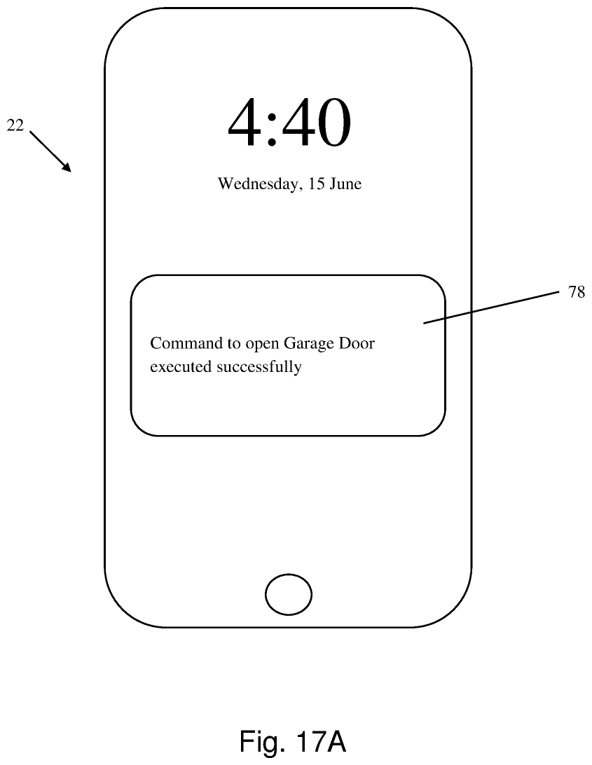

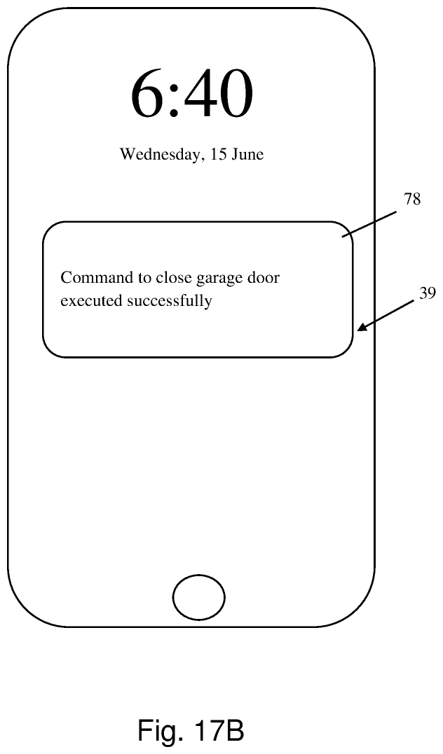

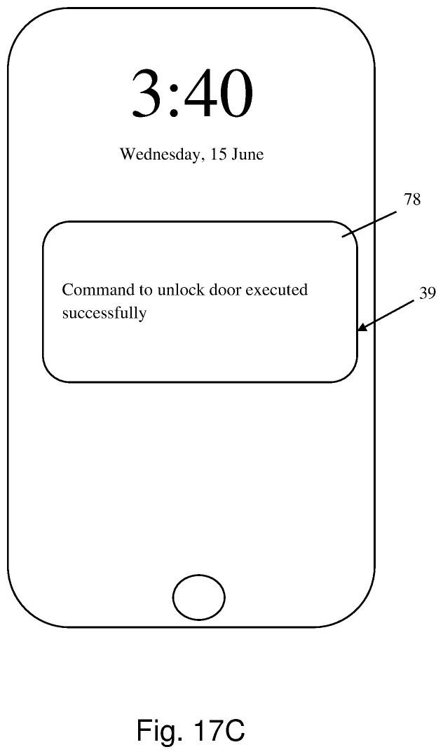

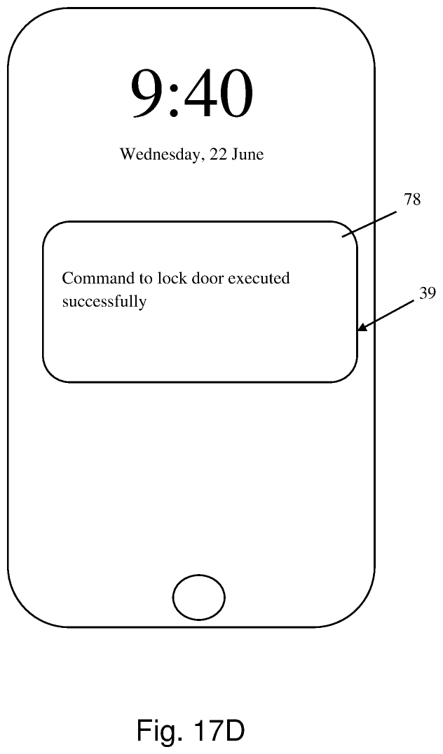

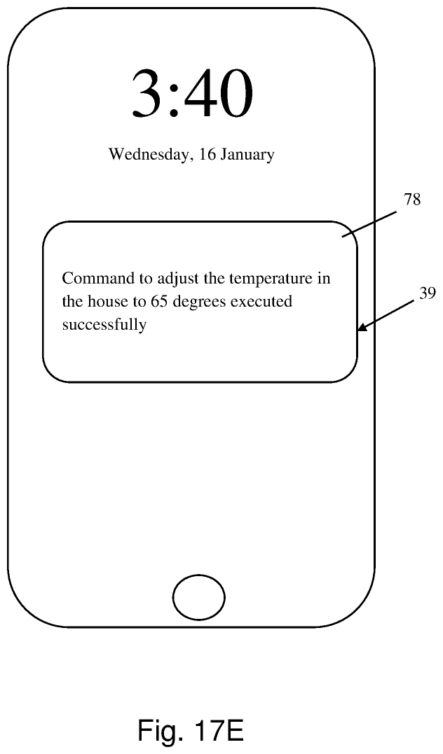

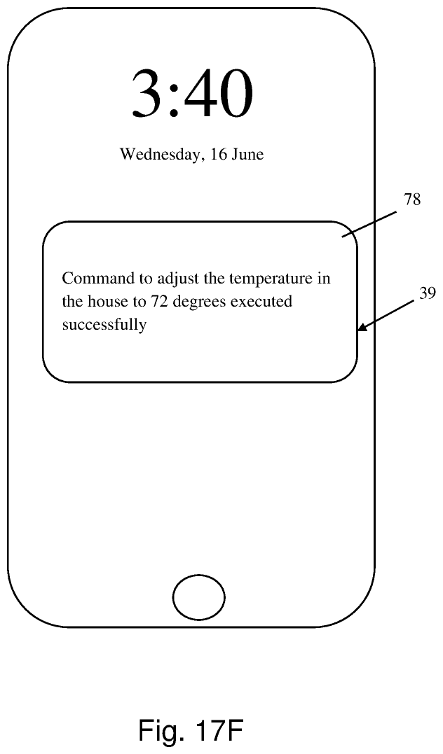

In step 226, the Jervis Systems Broker Service 58 informs the Jervis Systems Gateway 54 that either the command was executed successfully or if there is an error and that the command is unable to be executed as depicted by arrow 9 in FIG. 13. In step 228, the Jervis Systems Gateway 54 notifies the originator via SMS that the command was executed successfully or if there was an error as depicted by arrow 10 in FIG. 13. FIGS. 17A to 17F show schematic front views of a cell phone that show text messages 78 displayed on the display 39 of the cell phone 22 of the originator that the commands to operate the devices 74 was executed successfully. For example, FIG. 17A shows an example of a message 78 displayed on the display 39 of the cell phone 22 of the originator that the command to open the garage door was executed successfully. In one example, the device 74 may be a smart garage door opener that is connected to the internet. In this example, the Web Application or the API Service of solution sends a first command or signal to the garage door controller 72 to open the garage door. The garage door controller may include a transceiver 77 that receives the first command and then sends a first control signal to open the garage door.

The verification module 70 of the Jervis Systems Broker Service 58 verifies that this command was executed or keeps trying for a preconfigured number of attempts. The Jervis Systems Broker Service 58 then informs the Jervis Systems Gateway 54 that either the command to close the garage door was executed successfully or if there is an error and that this command is unable to be executed. The Jervis Systems Gateway 54 then notifies the originator via SMS that the command to open the garage door was executed successfully or if there was an error. If the user with the registered phone number wants to close the garage door, the process would perform steps 202-214. Then, in step 216, the user sends via their cell phone the SMS message associated with the command option (e.g. 4) provided to them by the Jervis Systems Gateway 54 to close the garage door to the Jervis Systems Gateway 54.

The Jervis Systems Gateway 54 passes this command to be executed to the Jervis Systems Broker Service 58. The Jervis Systems Broker Service 58 sends the command to close the garage door to the Web Application or API Service of the solution. The Web Application or the API Service of solution sends a second command or signal to the garage door controller to close the garage door. The transceiver receives the second command and then sends a second control signal to close the garage door. The verification module 70 of the Jervis Systems Broker Service 58 verifies that the command to close the garage door was executed (FIG. 17B) or keeps trying for a preconfigured number of attempts. The Jervis Systems Broker Service 58 informs the Jervis Systems Gateway 54 that either this command was executed successfully or if there is an error and that the command is unable to be executed. The Jervis Systems Gateway 54 then notifies the originator via SMS that the command to close the garage door was executed successfully or if there was an error.

Other devices can be included in this system and method allow a guest to execute commands to operate the device associated with the property. These devices include wireless integrated door locks, wireless integrated lights and switches, wireless integrated thermostats and other suitable devices. For example, this system and method can be utilized to turn on and off lights in the house with texting using wireless integrated lights and switches, and also to set a temperature or turn on the AC or heating with the wireless enabled thermostat. These steps may be performed without the use of a smart phone or mobile phone application.

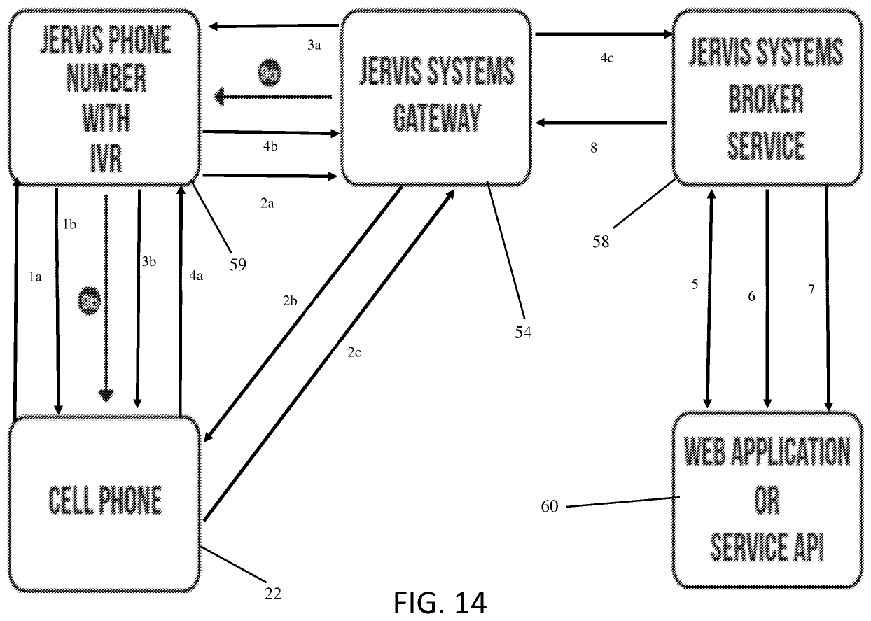

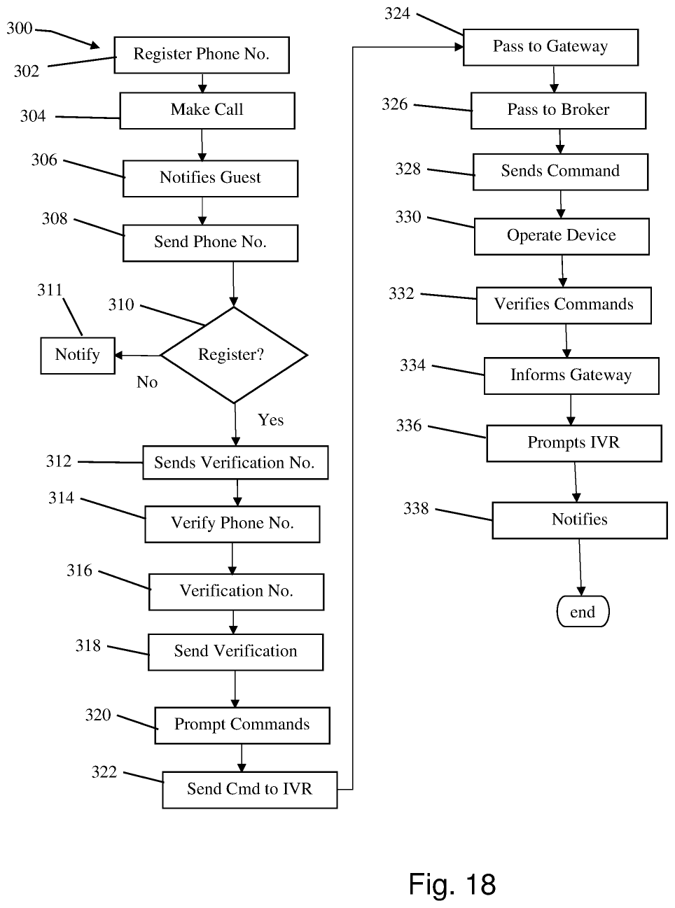

FIG. 18 shows a method 300 comprising operative sequence of steps for operating devices associated with the property according to a first embodiment. The method generally includes a user calling a phone number that is managed by the Jervis Systems Gateway 54. The user is then verified to be an authorized number and is prompted with a menu of options to select via an Interactive Voice Response (IVR) system 59 (FIG. 14). The menu prompts are mapped to commands. These commands will be sent and executed on services that are hosted online and have a publicly accessible API or is accessible from an Internet browser. The user is notified by the IVR 59 that the commands were successfully executed and can hang up or execute other commands. The user or originator may be a guest, cleaning company representative, handyman, property manager or associate or other type of user.

In particular, the method begins in step 302, in which a guest or other user registers the phone number of their cell phone with the Jervis Systems Gateway 54. In the registration process, the phone number is received and stored in the data store 68 of the Jervis Systems Gateway 54. The Jervis Systems Gateway 54 is configured such that only authorized phone numbers stored in the data store 68 of the Jervis Systems Gateway 54 during an approved period will be acted upon. In step 304, the user calls from the cell phone 22 of the authorized phone number to the Jervis Systems Gateway 54 as depicted by arrow 1a in FIG. 14. The phone number is integrated with the Jervis Systems IVR system 59 provided by the Jervis Systems Gateway 54. In step 306, the Jervis Systems IVR 59 welcomes them and asks them to wait while they check to determine if the phone number is registered as depicted by arrow 1b in FIG. 14. In step 308, Jervis Systems IVR 59 communicates the number called to the Jervis Systems Gateway 54 as depicted by arrow 2a in FIG. 14.

In step 310, the authenticator 66 of the Jervis Systems Gateway 54 checks the phone number of the cell phone 22 of the user and determines whether the phone number has been registered with the Jervis Systems Gateway 54. If the authenticator 66 of the Jervis System Gateway 54 was not able to find an authorized number, then in step 311, it would notify the Jervis Systems IVR to prompt or notify the user with a message that states “We are unable to find that you are registered in our system. Please contact your property owner or property manager to verify access”. If the authenticator 66 of the Jervis Systems Gateway 54 determines that the phone number is registered with the Jervis Systems Gateway 54 and it occurred during an approved time, then in step 312 the messaging system 64 of the Jervis System Gateway 54 sends a 2-4-digit verification number or code via a SMS message or email back to the cell phone as an email or text for the user to verify that this message originated from the cell phone to thereby provide number spoof protection as depicted by arrow 2b in FIG. 14. In step 314, the originator submits the received 2-4-digit verification number to Jervis Systems Gateway 54 via pressing in the number (detected via DTMF (dual tone multi frequency) signal recognition) or spoken via voice (numbers are detected via voice to text translation) as depicted by arrow 2c in FIG. 14. Instead of a number, the verification code can include letters, alphanumeric characters, punctuation characters, special character, letters or characters from foreign languages, other types of characters, or combinations of these types of characters.

In step 316, the Jervis Systems Gateway 54 prompts the Jervis Systems IVR 59 to notify the originator that they have been verified as depicted by arrow 3a in FIG. 14. In step 318, the Jervis Systems IVR 59 notifies the originator that they have been verified as depicted by arrow 3b in FIG. 14. In step 320, a menu prompt of commands that can be submitted via DTMF or voice submission is provided by the Jervis Systems IVR 59 as depicted by arrow 3b in FIG. 14. In step 322, the originator presses the number of the command they wish to execute on their cell phone or says the number of the command they wish to execute to the Jervis Systems IVR 59 managed by the Jervis Systems Gateway 54 as depicted by arrow 4a in FIG. 14. In step 324, the Jervis Systems IVR system 59 passes the numbers pressed or the numbers spoken via voice to the Jervis Systems Gateway 54 as depicted by arrow 4b in FIG. 14. The Jervis Systems Gateway 54 has a mapping of the numbers pressed or spoken to the command to be executed. In step 326, the Jervis Systems Gateway 54 passes the commands to be executed to the Jervis Systems Broker Service 58 as depicted by arrow 4c in FIG. 14.

In step 328, the Jervis Systems Broker Service 58 sends commands to the Web Application or API Service of the solution as depicted by arrow 6 in FIG. 14. The Jervis Systems Broker Service 58 maintains a connection to the Web Application or API Service of solution to enable the commands to be sent to them. In step 330, the Web Application or the API Service of solution sends the commands to the device to operate the device. In step 332, the verification module 70 of the Jervis Systems Broker Service 58 verifies that the commands were executed to operate the device or not executed to operate the device as depicted by arrow 7 in FIG. 14. The verification module keeps trying for a preconfigured number of attempts to make this determination or keeps trying for a preconfigured number of attempts. The number of attempts is configurable in the Jervis Systems Gateway Dashboard (administration panel).

In step 334, the Jervis Systems Broker Service 58 informs the Jervis Systems Gateway 54 that either the command was executed successfully or if there is an error and that the command is unable to be executed as depicted by arrow 8 in FIG. 14. In step 336, the Jervis Systems Gateway 54 prompts the Jervis Systems IVR system 59 to notify the originator while they are on the phone that the command was executed successfully or if there was an error as depicted by arrow 9a in FIG. 14. In step 338, the Jervis Systems IVR system 59 notifies the user that the command was executed successfully or if there was an error, says Goodbye and disconnects the phone connection as depicted by arrow 9b in FIG. 14. In one example as shown in Figure, the device 74 may be a smart garage door opener connected to the internet. In this example, the Web Application or the API Service of solution sends a first command or signal to the garage door controller to open the garage door. The garage door controller may include a transceiver 77 that receives the first command and then sends a first control signal to open the garage door.

The verification module of the Jervis Systems Broker Service 58 verifies that this command was executed or keeps trying for a preconfigured number of attempts. The Jervis Systems Broker Service 58 then informs the Jervis Systems Gateway 54 that either the command to open the garage door was executed successfully or if there is an error and that this command is unable to be executed. The Jervis Systems Gateway 54 prompts the Jervis Systems IVR system 59 to notify the originator while they are on the phone that the command to open the garage door was executed successfully or if there was an error. The Jervis Systems IVR system 59 notifies the user that the command to open the garage door was executed successfully or if there was an error, says Goodbye and disconnects the phone connection.

If the user with the registered phone number wants to close the garage door, the process would perform steps 302 to 320. Then, in step 322, the originator presses the number of the command to close the garage door on their phone or says the number of that command to the Jervis Systems IVR 59 managed by the Jervis Systems Gateway 54. The Jervis Systems IVR 59 passes the numbers pressed or the numbers spoken via voice to the Jervis Systems Gateway 54. The Jervis Systems Gateway 54 has a mapping of the numbers to command to be executed. The Jervis Systems Gateway 54 then passes the command to close the garage door to the Jervis Systems Broker Service 58. The Jervis Systems Broker Service 58 then sends this command to close the garage door to the Web Application or API Service of the solution.

The Web Application or the API Service of solution sends a second command or signal to the garage door controller to close the garage door. The transceiver receives the second command and then sends a second control signal to close the garage door. The verification module of the Jervis Systems Broker Service 58 verifies that the command to close the garage door was executed or keeps trying for a preconfigured number of attempts. The Jervis Systems Broker Service 58 informs the Jervis Systems Gateway 54 that either this command was executed successfully or if there is an error and that the command is unable to be executed. The Jervis Systems Gateway 54 prompts the Jervis Systems IVR system 59 to notify the originator while they are on the phone that the command to open the garage door was executed successfully or if there was an error. Then, the Jervis Systems IVR system 59 notifies the user that the command to open the garage door was executed successfully or if there was an error, says Goodbye and disconnects the phone connection.

Other devices can be included in this system and method to allow a user to execute commands to operate that device associated with the property. These devices may include wireless integrated door locks, wireless integrated lights and switches, wireless integrated thermostats and other suitable devices. For example, this system and method can be utilized to turn on and off lights in the house with texting or calling using wireless integrated lights and switches, and also to set a temperature or turn on the AC or heating with the wireless enabled thermostat. These steps may be performed without the use of a smart phone or mobile phone application. Thus, the present invention provides a property management system and method that securely streamlines the rental management experience and guest user experience. The present invention further allows operation of devices at the property such as doors and HVAC systems by texting or by voice command without having to use a separate device for each device to operate the device.

Although various embodiments of the disclosed property management system and method have been shown and described, modifications may occur to those skilled in the art upon reading the specification. The present application includes such modifications and is limited only by the scope of the claims.

What is claimed is:

1. A computer-implemented method for operating one or more devices comprising the following operations performed by at least one processor:
registering a phone number associated with a phone of a user;
receiving a first message or call from a phone of the user;
performing a query by an authenticator to determine if the phone number of the phone of the user is registered;
sending one or more commands to the phone of the user for the user to select to operate the one or more devices if the phone number of the phone of the user is registered;
receiving a command selected by the user to operate a selected device from the one or more commands sent to the phone of the user to operate the one or more devices; and
operating the one or more devices upon executing the command selected by the user.

2. The computer-implemented method of claim 1 further comprising sending a second message having a verification code back to the phone for the user send back to verify that the first message originated from the phone of the user prior to sending one or more commands to the phone of the user to operate one or more devices.

3. The computer-implemented method of claim 2 further comprising sending a third message back to the phone of the user, wherein the third message communicates to the user that the first message originated from the phone of the user.

4. The computer-implemented method of claim 1 further comprising verifying through operation of a verification module whether the one or more commands were executed to operate the one or more devices.

5. The computer-implemented method of claim 4, further comprising notifying the user through the phone of the user that the command was executed successfully or if there was an error in the execution of the command.

6. The computer-implement method of claim 4, further comprising operating a verification module to perform a preconfigured number of attempts to determine whether the one or more commands were executed to operate the one or more devices.

7. The computer-implemented method of claim 1, wherein receiving a first message or call from a phone of the user includes receiving an SMS message from the phone of the user.

8. The computer-implemented method of claim 1, wherein sending one or more commands to the phone of the user for the user to select to operate the one or more devices if the phone number of the phone of the user is registered includes sending one or more SMS messages that are mapped into the one or more commands.

9. The computer-implemented method of claim 1 wherein receiving a first message or call from a phone of the user includes receiving a call from the phone of the user.

10. The computer-implemented method of claim 9, wherein the phone number is integrated with an IVR system.

11. The computer-implemented method of claim 9 further comprising notifying the user of the phone through an IVR system that the phone number of the phone of the user has been registered.

12. The computer-implemented method of claim 1, wherein sending one or more commands to the phone of the user for the user to select to operate the one or more devices if the phone number of the phone of the user is registered includes sending by an IVR system commands that can be submitted via DTMF or voice submission by the user of the phone.

13. The computer-implemented method of claim 1, wherein the one or more devices includes a door lock.

14. The computer-implemented method of claim 1, wherein the user is a guest of a rental property, wherein the one or more devices are associated with the rental property.

15. A non-transitory computer-readable storage medium storing executable instructions that, as a result of being executed by one or more processors of a computer system, cause the computer system to at least:
register a phone number associated with a phone of a user;
receive a message or call from a phone of the user;
perform a query by an authenticator to determine if the phone number of the phone of the user is registered;
send one or more commands to the phone of the user for the user to select to operate the one or more devices if the phone number of the phone of the user is registered;
receive a command selected by the user to operate a selected device from the one or more commands sent to the phone of the user to operate the one or more devices; and
operate the one or more devices upon executing the command selected by the user.

16. The non-transitory computer-readable storage medium of claim 15, wherein sending one or more commands to the phone of the user for the user to select to operate the one or more devices if the phone number of the phone of the user is registered includes one or more SMS messages that are mapped into the one or more commands.

17. The non-transitory computer-readable storage medium of claim 15, wherein sending one or more commands to the phone of the user for the user to select to operate the one or more devices if the phone number of the phone of the user is registered includes providing by an IVR system commands that can be submitted via DTMF or voice submission.

18. The non-transitory computer-readable storage medium of claim 15 wherein the instructions further including instructions that, as a result of being executed by one or more processors, cause the computer system to:
verify through operation of a verification module whether the one or more commands were executed to operate the one or more devices.

19. The non-transitory computer-readable storage medium of claim 15 wherein the instructions further including instructions that, as a result of being executed by one or more processors, cause the computer system to:
send a second message having a verification code back to the phone for the user send back to verify that the first message originated from the phone of the user prior to sending one or more commands to the phone of the user to operate one or more devices.

20. The non-transitory computer-readable storage medium of claim 15, wherein the user is a guest of a rental property, wherein the one or more devices are associated with the rental property.
